(19) United States
(12) Patent Application Publication
(10) Pub. No.: US 2006/0027678 A1
(43) Pub. Date: Feb. 9, 2006

(54) Headlamp cleaner

(76) Inventor: Hiroaki Kimura, Shizuoka (JP)

Correspondence Address: FISH & RICHARDSON P.C., P.O. BOX 1022, MINNEAPOLIS, MN, 55440-1022, US

(21) Appl. No.: 11/187,763

(22) Filed: Jul. 22, 2005

(30) Foreign Application Priority Data
Aug. 4, 2004 (JP) 2004-227696

(51) Int. Cl. B05B 1/10

(52) U.S. Cl. 239/284.2

(57) ABSTRACT

A headlamp cleaner including an injection nozzle 40 for injecting cleaning fluid, a piston 20 supporting the injection nozzle, a cylinder 10 supporting the piston so that the piston moves between an injection position and a retracted position through an opening 91 in a bumper 90 and a nozzle cover 70 mounted so as to be moved together with the piston to thereby open and close the opening in the bumper, wherein an end portion of the cylinder is attached to the opening in the bumper via a bracket 50, the bracket has positioning walls 524, 525 situated on an inside of an edge of the opening, the nozzle cover has positioning portions 732, 741 abutting with the positioning walls of the bracket, and the positioning portions abuts with the positioning walls so that the nozzle cover is positioned in place when the piston is in the retracted position.

### BACKGROUND OF THE INVENTION

1. Field of the Invention

The present invention relates to a novel headlamp cleaner and more particularly to a technique for ensuring the positioning of a nozzle covers for covering an injection nozzle when the same nozzle is retracted.

2. Description of the Background Art

A headlamp cleaner is known which cleans a front lens of a headlamp by injecting cleaning fluid against the front lens when the front lens of the headlamp gets dirty as a result of running on a road in a bad condition.

There have been proposed various types of headlamp cleaners, and among them is a headlamp cleaner of a type which is disposed on a back side of a bumper and in which when the headlamp cleaner injects cleaning fluid, an injection nozzle is made to protrude to an outside of the bumper from an opening provided in the bumper. Whereas when no injection of cleaning fluid is necessary and hence the headlamp cleaner is retracted, the injection nozzle is retracted on the back side of the bumper. Then, when the injection nozzle is made to exit from and enter the opening provided in the bumper, since the external appearance of the bumper is deteriorated in case the opening in the bumper is left as it is when the injection nozzle is so retracted to cope with this, a technique is proposed in, for example, Japanese Patent Unexamined Patent Publication JP-A-2002-37037 in which the opening provided in the bumper is covered with a nozzle cover from an outside of the opening when the injection nozzle is retracted. As in the case with the headlamp cleaner shown in the JP-A-2002-37037, in the event that the opening in the bumper is made to be covered with the nozzle cover when the nozzle is retracted, the opening in the bumper is made invisible. Accordingly, the bumper is allowed to look smart, and hence the external appearance of the bumper is improved.

Incidentally, the nozzle cover is desirably in a size which is necessarily sufficient to cover the opening in the bumper.

In the headlamp cleaner shown in The JP-A-2002-37037 mentioned above, however, since there is provided no means for positioning the nozzle cover, there may be occurring a case where a positionally unmatched state or positional deviation is caused between the nozzle cover and the opening in the bumper when the injection nozzle is retracted. In addition, there is provided no means for positioning a distal end portion of the cylinder which supports the piston having the injection nozzle relative to the opening in the bumper and fixing the distal end portion so positioned to the opening, there may be occurring a case where a positional deviation between the movement locus of the injection nozzle and the opening in the bumper. In particular, since the positional relationship between the position of the opening in the bumper and another portion of a vehicle body (where the cylinder is fixed) cannot be said to be regulated with good accuracy, there is less opportunity where the aforementioned positional deviations do not occur.

When the aforementioned positional deviations occur, there are caused problems that the appearance of a peripheral portion of the opening in the bumper is damaged and that the injection nozzle interferes with the bumper while the nozzle is moving.

### SUMMARY OF THE INVENTION

In view of the above problems, one of objects of the present invention is to ensure the positioning of the distal end portion of the cylinder and also the nozzle cover relative to the opening in the bumper.

With a view to solving the problem, according to a first aspect of the present invention, there is provided a headlamp cleaner, comprising:

an injection nozzle for injecting cleaning fluid when in operation;

a piston supporting the injection nozzle;

a cylinder supporting the piston so that the piston moves between an injection position and a retracted position through an opening in a bumper; and

a nozzle cover mounted so as to move together with the piston to thereby open and close the opening in the bumper,

wherein an end portion of the cylinder is attached to the opening in the bumper via a bracket,

the bracket has a positioning wall situated on an inside of an edge of the opening in the bumper,

the nozzle cover has a positioning portion abutting with the positioning wall of the bracket, and

the positioning portion of the nozzle cover abuts with the positioning wall of the bracket so that the nozzle cover is positioned in place, when the piston is moved to the retracted position.

According to a second aspect of the present invention, as set forth in the first aspect of the present invention, it is preferable that the bracket has an abutment wall, of which an end face abuts an opening edge portion on a back side of the bumper via an elastic member.

According to a third aspect of the present invention, as set forth in the second aspect of the present invention, it is preferable that the abutment wall of the bracket is positioned so as to surround the positioning wall from an outside thereof.

According to a fourth aspect of the present invention, as set forth in the first aspect of the present invention, it is preferable that the bumper has an engagement projection around the opening,

the bracket has an attachment piece having an engagement hole, and

the engagement hole in the attachment piece engages with the engagement projection on the bumper so that the bracket is fixed to the bumper.

According to a fifth aspect of the present invention, as set forth in the fourth aspect of the present invention, it is preferable that the attachment piece and the positioning wall are arranged so as to form a quadrangle as viewed in a section taken along a plane which is perpendicular to a direction in which the piston moves, and

the nozzle cover has ribs which abut with the positioning wall and the attachment piece separately, so that the nozzle cover is positioned in place.

According to a sixth aspect of the present invention, as set forth in the first aspect of the present invention, it is preferable that the bracket comprises:

a first connecting portion connecting the cylinder and the bumper to the bracket; and

a second connecting portion connecting the bumper to the bracket.

According to a seventh aspect of the present invention, as set sixth in the first aspect of the present invention, it is preferable that the first and second connecting portions are integral with each other.

According to an eighth aspect of the present invention, as set forth in the sixth aspect of the present invention, it is preferable that the first connecting portion includes:

a cylindrical portion connected with a front end of the cylinder; and

a attachment piece connecting with a lower end of the bumper.

According to a ninth aspect of the present invention, as set forth in the sixth aspect of the present invention, it is preferable that the positioning wall is provided on the second connecting portion.

According to a tenth aspect of the present invention, as set forth in the second aspect of the present invention, it is preferable that the bracket comprises:

a first connecting portion connecting the cylinder and the bumper to the bracket; and

a second connecting portion having the abutment wall and connecting the bumper to the bracket.

According to an eleventh aspect of the present invention, as set forth in the first aspect of the present invention, it is preferable that the nozzle cover comprises:

a cover portion;

a attachment leg portion protruded from the cover portion to the cylinder for attaching the cover portion to the bracket;

a first rib extending in horizontal direction from the attachment leg portion and connected to the cover portion; and

a second rib extending in vertical direction from the attachment leg portion and connected to the cover portion.

According to a twelfth aspect of the present invention, as set forth in the eleventh aspect of the present invention, it is preferable that the first rib comprising:

a positioning edge as the positioning portion, which is parallel to a cylinder axis to thereby determine the position of the nozzle cover in the horizontal direction; and

an inclined edge of which width is reduced toward to the cylinder side, and wherein the second rib comprising:

a positioning edge as the positioning portion, which is parallel to the cylinder axis to thereby determine vertical position of the nozzle cover; and

an inclined edge of which width is reduced toward to the cylinder side.

Consequently, in the headlamp cleaner of the present invention, the cylinder is fixed in such a state that the cylinder is positioned relative to the bumper by the bracket and the nozzle cover is positioned relative to the bracket to thereby be positioned relative to the bumper, too.

According to a first aspect of the present invention, there is provided a headlamp cleaner including an injection nozzle for injecting a cleaning fluid when in operation, a piston which supports the injection nozzle, a cylinder which supports the piston so that the piston can be moved between an injection position and a retracted position through an opening in a bumper and a nozzle cover that is mounted in such a manner as to be moved together with the piston to thereby open and close the opening in the bumper, an end portion of the cylinder being attached to the opening in the bumper via a bracket, wherein the bracket has a positioning wall that is to be situated on an inside of an edge of the opening in the bumper, and wherein the nozzle cover has a positioning portion which is to be brought into abutment with the positioning wall of the bracket, whereby the positioning portion of the nozzle cover is brought into abutment with the positioning wall of the bracket, so that the nozzle cover is positioned in place, when the piston is moved to the retracted position.

Consequently, in the headlamp cleaner of the present invention, the cylinder is fixed in such a state as to be positioned relative to the bumper by the bracket. Then, since the nozzle cover is positioned through the abutment of the positioning portion of the nozzle cover with the positioning wall of the bracket that is fixed to the bumper when the injection nozzle is retracted, there is no case where the position of the nozzle cover deviates largely from the opening in the bumper, and hence there is no risk that the appearance is damaged due to the positional deviation between the nozzle cover and the opening in the bumper.

According to the second aspect of the present invention, since the bracket has an abutment wall, of which the end face abuts the opening edge portion on the back side of the bumper via the elastic member, the occurrence of loosening between the bracket and the bumper is prevented, whereby the bracket is stably supported on the bumper.

According to the third aspect of the present invention, since the abutment wall of the bracket is positioned in such a manner as to surround the positioning wall from an outside thereof, the position of the piston and hence the nozzle can be arranged in a proper positional relationship by making the positioning wall abut with or approach the opening edge of the opening in the bumper.

According to the fourth aspect of the present invention, since the opening in the bumper has the engagement projection and the bracket has the attachment piece having an engagement hole, whereby the engagement hole in the attachment piece is brought into engagement with the engagement projection on the bumper, so that the bracket is fixed to the bumper, the work of arranging for the bumper to support the bracket can be facilitated.

According to the fifth aspect of the present invention, since the attachment piece and the positioning wall are arranged in such a manner as to form the quadrangle as viewed in the section taken along the plane which is perpendicular to the direction in which the piston moves and the nozzle cover has, as positioning portions, the ribs which abuts with the positioning wall and the attachment piece separately, the nozzle cover is positioned in all directions within the plane substantially perpendicular to the moving direction of the piston, whereby the loosening of the nozzle cover is prevented in an ensured fashion which would otherwise be caused when the injection nozzle is retracted.

### BRIEF DESCRIPTION OF THE DRAWINGS

FIG. 1 is a schematic side view which shows together with FIG. 2 an overall construction of a headlamp cleaner according to an embodiment of the present invention, which is in a retracted state;

FIG. 2 is a schematic side view which shows the headlamp cleaner in an injecting state;

FIG. 3 is an exploded perspective view showing a bracket, an elastic member, a nozzle cover and a bumper;

FIG. 4 is a perspective view which is partially cut away to show a main part of the headlamp cleaner; and

FIG. 5 is a schematic perspective view which shows a state in which the bracket is attached to the bumper.

### DETAILED DESCRIPTION OF THE PREFERRED EMBODIMENTS

Hereinafter, a best mode for carrying out a headlamp cleaner of the present invention will be described by reference to the accompanying drawings.

A headlamp cleaner 1 includes a cylinder 10, a piston 20, a nozzle holder 30, an injection nozzle 40, a bracket 50, an elastic cover packing 60 and a nozzle cover 70.

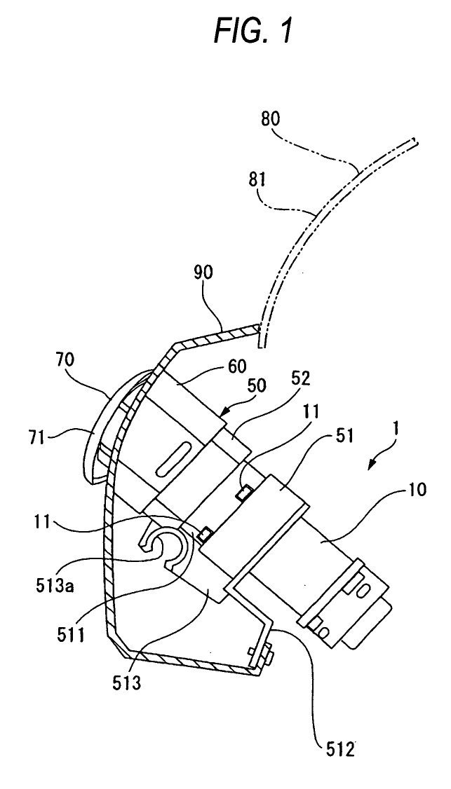

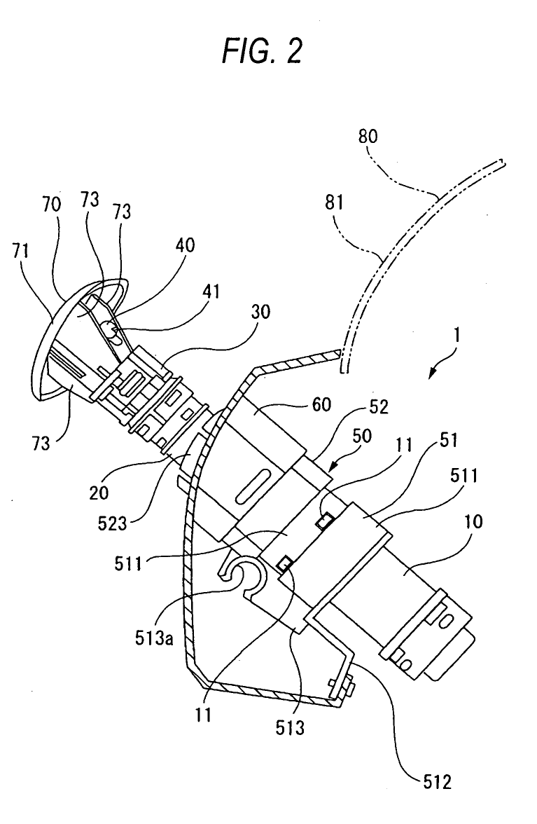

The cylinder 10 is formed into a cylindrical shape, and the piston 20 is slidably supported in the cylinder 10. When retracted, the piston 20 is held at a retracted position shown in FIG. 1 by means of a spring, not shown, that is provided within the cylinder 10. Cleaning fluid is supplied into the interior of the cylinder 10 via a cleaning fluid supply pipe, not shown. As the pressure of the cleaning fluid within the cylinder 10 increases, the pressure of the cleaning fluid overcomes the force of the spring within the cylinder 10 and the piston 20 is made to protrude gradually from the cylinder 10, whereby the piston 20 is moved to an injecting position shown in FIG. 2.

The nozzle holder 30 is attached to a distal end portion of the piston 20, and the injection nozzle 40 is supported by the nozzle holder 30. As has been described above, when the piston 20 is moved to the injecting position by virtue of the pressure of cleaning fluid in association with the supply thereof into the cylinder 10, the pressure of cleaning fluid within the cylinder 10 increases further, and a check valve provided in the cylinder 10 or the piston 20 is opened to thereby open a flow path extending from the cylinder 10 to the injection nozzle 40 via the piston 20 and the nozzle holder 30 for communication. Whereby cleaning fluid is injected from an injection port 41 of the injection nozzle 40 towards a front lens 81 of a headlamp 80.

When the supply of cleaning fluid into the interior of the cylinder 10 is stopped upon the completion of the cleaning of the front lens 81 of the headlamp 80, since the pressure within the cylinder 10 decreases, the spring force of the spring in the cylinder 10 overcomes the pressure that has so decreased. Then, the piston 20 is withdrawn into the interior of the cylinder by virtue of the spring force, whereby the piston 20 is moved back to the retracted position shown in FIG. 1.

As has been described above, when the piston 20 is moved between the retracted position and the injecting position, the injection nozzle 40, which is supported on the distal end portion of the piston 20 via the nozzle holder 30, is moved between an inside and an outside of a bumper 90 through an opening 91 formed in the bumper 90. Then, when the piston 20 is at the retracted position, the nozzle cover 70 is in abutment with a front side of the bumper 90 so as to cover the opening 91. The nozzle cover 70 is fixed to the nozzle holder 30 in such a manner as to surround the injection nozzle 40 from substantially the front thereof.

The cylinder 10 is fixed to the vehicle body or to the bumper 90 in this embodiment via the bracket 50. The bracket 50 is made up of a first connecting portion 51 and a second connecting portion 52, which are formed integrally with each other. The first connecting portion 51 is a portion that is to be connected to the cylinder 10, as well as being fixed to the bumper 90, and the second connecting portion 52 is a portion that is to be connected to the opening 91 in the bumper 90.

The first connecting portion 51 is made up of a cylindrical portion 511, an attachment piece 512 and a hose support portion 513, which are formed integrally with each other, and some engagement holes 511a, 551a are formed circumferentially at intervals on the cylindrical portion 511. The attachment piece 512 is provided on the cylindrical portion 511 in such a manner as to protrude from a side thereof, and a mounting hole 512a is formed in the attachment piece 512. The hose support portion 513 is also provided on the cylindrical portion 511 in such a manner as to protrude from a side thereof, and a substantially circular supporting notch is formed in the hose support portion 513.

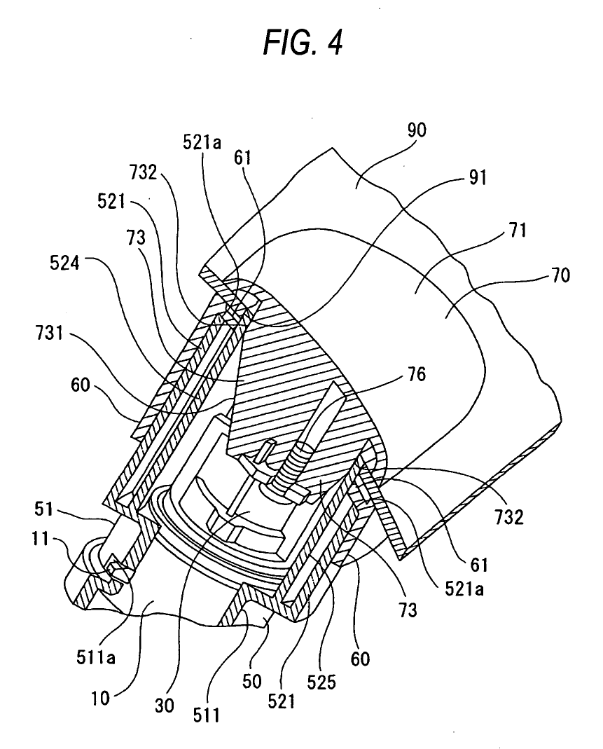

The cylindrical portion 511 of the first connecting portion 51 of the bracket 50 is fitted on a front end portion of the cylinder 10, and engagement projections 11, 11 which are provided on an outer circumferential surface of the front end portion of the cylinder 10 in such a manner as to protrude therefrom are then brought into engagement with the engagement holes 551a, 511a which are formed in the cylindrical portion 511 of the bracket 50 (refer to FIG. 4), whereby the bracket 50 and the cylinder 10 are connected integrally with each other.

Then, the attachment piece 512 of the bracket 50 is fixed to a lower end portion of the bumper 90 with a bolt and a nut or a tapping screw (refer to FIGS. 1, 2).

The second connecting portion 52 of the bracket 50 is integrally connected to a front end of the first connecting portion 51 and is formed substantially into an angular tube as a whole. The second connecting portion 52 has an abutment wall 521 which is formed substantially into an angular tube, and vertically central parts of portions of the abutment wall 521 which constitute left and right sides thereof protrude further forward than the remaining parts thereof. Then, slits 522, 522 are formed in such a manner as to extend rearward from upper and lower edges of the parts which protrude further forward the remaining parts, and parts 523, 523 between the slits 522, 522 are made to constitute attachment pieces. Then, engagement holes 523a, 523a are formed in parts of the attachment pieces which protrude further forward than the other parts thereof in such a manner as to extend in a vertical direction. Then, external surfaces of the parts of the abutment wall 521 which are made to constitute the attachment pieces 523, 523 are formed in such a manner as to be situated further inward than external surfaces of the other parts thereof. Consequently, front ends of parts of the abutment wall 521 which constitute the parts other than the attachment pieces 523, 523 are situated at positions which are further outward than the external surfaces of the attachment pieces 523, 523, and the front end face 521a is made to constitute an abutment surface.

Positioning walls 524, 524 are formed on an inside of the abutment wall 521 in upper corner portions thereof in such a manner as to face each other while being slightly spaced apart from each other, and upper end portions of the positioning walls 524, 524 extend to the vicinity of the center. Then, end portions of the positioning walls 524, 524 are connected to the inside of the abutment wall 521, and furthermore, front ends of the positioning walls 524, 524 protrude further forward than the front end or the abutment surface 521a of the abutment wall 521. In addition, another positioning wall 525 is formed on the inside of the abutment wall 521 at a lower portion thereof in such a manner as to face the inside of the abutment wall 521 with a slight space provided therebetween, and the both ends of the positioning wall 525 are connected to an internal surface of the abutment wall 521 at side portions thereof. Furthermore, front end of the positioning wall 525 is made to protrude further forward than the front end or the abutment surface 521a of the abutment wall 521.

The elastic cover packing 60 is made of an elastic material such as a synthetic rubber or the like and is formed into an angular tube-like shape, which is sized big enough to cover the second connecting portion 52 of the bracket 50 excluding a rear end portion of the second connecting portion 52 from an outside thereof. In addition, peak-like portions 61 are formed at a front end portion of the elastic cover packing 60 in such a manner as to extend inward from upper and lower portions thereof, and the peak-like portions 61 so formed are made to be brought into abutment with the front end face or the abutment surface 521a of the abutment wall 521 when the elastic cover packing 60 is fitted on the second connecting portion 52 of the bracket 50.

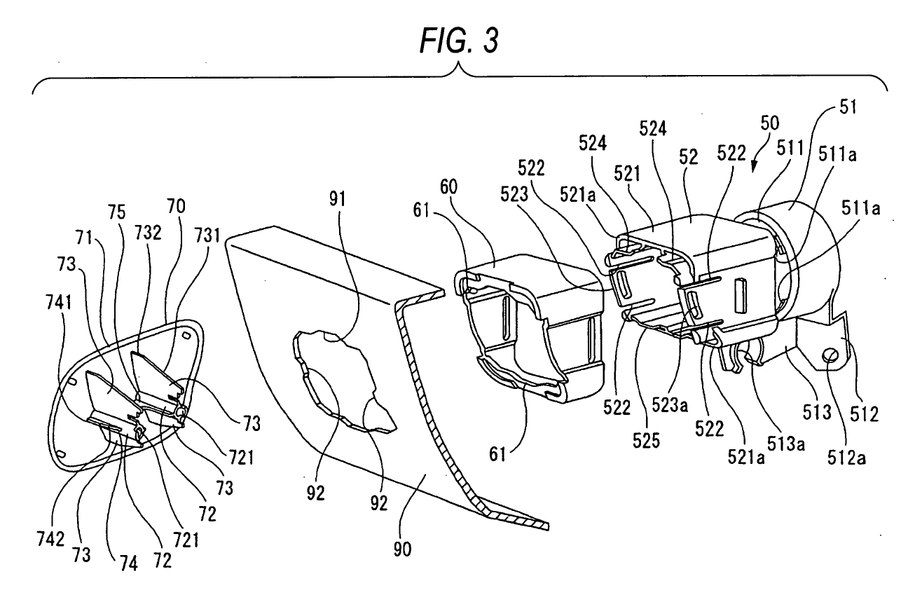

The nozzle cover 70 is made up of a cover portion 71, attachment leg portions 72, 72 and a plurality of ribs 73, 73, 74, 74 and 75, 75, which are formed integrally. Note that in FIG. 3, the nozzle cover 70 is shown as being oriented such that the nozzle cover 70 is opened sideways at an angle of about 90° relative to the orientation of the bracket 50 and the elastic cover packing 60, so that a back side of the nozzle cover 70 can be visible.

The cover portion 71 of the nozzle cover 70 is formed into a shape which results by bending a plate-like member so as to follow a frontal shape of the bumper 80. The attachment leg portions 72, 72 are each formed into a circular cylinder. Also, the attachment leg portions 72, 72 are provided in such a manner as to extend rearward from positions which are transversely spaced apart from each other on a back side of the cover portion 71. Screw holes are opened in rear end faces of the attachment leg portions 72, 72, respectively. The ribs 73, 73 are formed so as to connect the back side of the cover portion 71 to upper and lower sides of the attachment leg portions 72, 72. Also, the ribs 73, 73 are formed in such a manner as to extend upward and downward from the attachment leg portions 72, 72 as viewed from the rear thereof. Upper and lower edges of these ribs 73, 73 are made up of inclined edges 731, 731 and positioning edges 732, 732. The positioning edges 732, 732 constitute front end portion, which is a portion of the cover portion 71 side, and are formed so as to extend substantially in parallel with the axial direction of the attachment leg portions 72, 72. The inclined edges 731, 731 constitute portions which continue to the rear of the positioning edges 732, 732, respectively, and are inclined in such a manner as to approach external sides of the attachment leg portions 72, 72 as they extend rearward. The ribs 74, 74 are formed in such a manner as to connect the cover portion 71 to external sides of the attachment leg portions 72, 72 and are also formed in such a manner as to extend sideways outward from the attachment leg portions 72, 72 as viewed from the rear. Side edges of the ribs 74, 74, which are opposite to a portion connected to the attachment leg portions 72, 72, are made up of positioning edges 741, 741 situated on the side of the cover portion 71, and inclined edges 742, 742. The positioning edges 741, 741 are formed in such a manner as to extend substantially in parallel with the axial direction of the attachment leg portions 72, 72. The inclined edges 742, 742 continue to the rear of the positioning edges 741, 741 and are inclined in such a manner as to approach the attachment leg portions 72, 72 as they extend rearward. The ribs 75, 75 are formed in such a manner as to connect the cover portion 71 to internal sides of the attachment leg portions 72, 72 and are also formed in such a manner as to extend sideways inward from the attachment leg portions 72, 72 as viewed from the rear.

The ribs 73, 73, 74, 74 and 75, 75 function to reinforce the attachment leg portions 72, 72, and additionally, the ribs 73, 73 and 74, 74 function to position the cover portion 71 as will be described later on.

The nozzle cover 70 is fixed to a front end of the nozzle holder 30 by passing screws 76, 76 through the nozzle holder 30 from the rear thereof so as to be securely screwed into the screw holes 721, 721 which are opened in the rear end faces of the attachment leg portions 72, 72 (refer to FIG. 4). Then, the injection nozzle 40, which is supported by the nozzle holder 30, is positioned between the attachment leg portions 72, 72.

The opening 91 that is opened in the bumper 90 is formed into a shape which substantially matches the external shapes the positioning walls 524, 524, 525. The attachment pieces 523, 523, and engagement projections 92, 92 are provided substantially at vertically central positions of left- and right-hand side edges of the opening 91 in such a manner as to protrude inward therefrom (refer to FIG. 3).

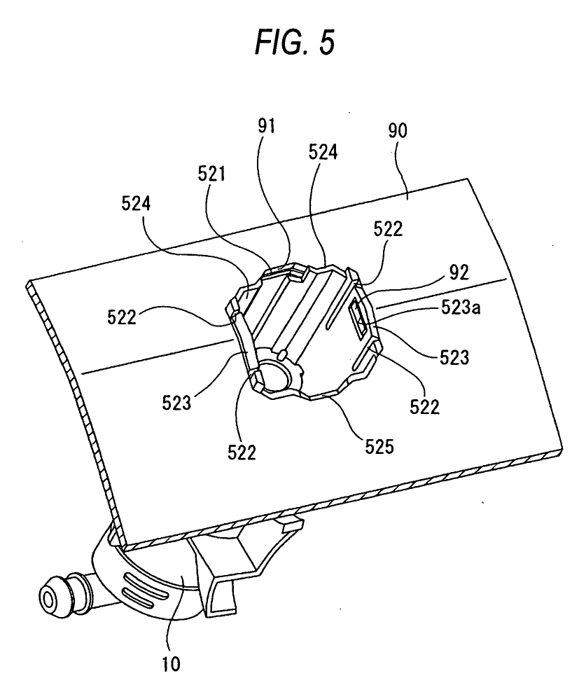

Then, the attachment pieces 523, 523 and the positioning walls 524, 524, 525 of the bracket 50 on which the elastic cover packing 60 is fitted as has been described above are passed through the opening 91 in the bumper 90 from the rear. In this operation, the attachment pieces 523, 523 are put in such a state that they are deflected slightly inward. When the deflecting force applied to the attachment pieces 523, 523 is released as soon as the attachment pieces 512, 512 and the positioning walls 524, 524, 525 have been passed through the opening 91 in the bumper 90, the attachment pieces 523, 523 are allowed to restore their original states and the engagement projections formed on the opening 91 in the bumper 90 are brought into engagement with the engagement holes 523a, 523a in the attachment pieces 523, 523. Therefore, the front end portion of the bracket 50 is supported in the opening 91 in the bumper 90. Then, the attachment pieces 523, 523 and the positioning walls 524, 524, 525 are positioned on the inside of the opening edge of the opening 91 in the bumper 90 (refer to FIGS. 4, 5). In addition, the front end or the abutment surface 521a of the abutment wall 521 is put in such a state that the abutment surface 521a abuts the back side of the opening 91 in the bumper 90 in the vicinity of the opening edge thereof (refer to FIG. 4). Therefore the bracket 50 is supported stably in the opening 91 in the bumper 90. Consequently, the position of the cylinder 10 becomes stable and hence the positions of the piston 20, which is supported in the cylinder 10, and the injection nozzle 40, which is supported on the piston 20, also become stable.

The nozzle cover 70 is fixed to the nozzle holder 30 after the bracket 50 has been attached to the bumper 90. Then, the opening 91 in the bumper 90 is covered by the cover portion 71 of the nozzle cover 70 from the front thereof. Then, with the piston 20 being located at the retracted position shown in FIG. 1, the position of the nozzle cover 71 is stabilized by the positioning walls 524, 524 and 525 and the attachment pieces 523, 523 of the bracket 50.

Namely, the positioning edges 732, 732 of the ribs 73, 73, which are provided on the nozzle cover 70, abut against internal sides of the positioning walls 524, 524 on the upper side of the bracket 50 in the upper part of the abutment wall 521 and abut against an internal side of the positioning wall 525 on the lower side of the bracket 50 in the lower part of the abutment wall 521. Accordingly, the nozzle cover 70 is positioned relative to the bracket 50 in a vertical direction. In addition, the positioning edges 732, 732 of the ribs 74, 74, which are provided on the nozzle cover 70, abut against internal sides of the attachment pieces 523, 523 of the bracket 50, whereby the nozzle cover 70 is positioned relative to the bracket 50 in a transverse direction.

As has been described heretofore, the positional relationship between the bracket 50 and the opening 91 in the bumper 90 is regulated properly through the direct support of the bracket 50 relative to the opening 91 in the bumper 90. Since the nozzle cover 70 is positioned relative to the bracket 50, which is positioned properly relative to the opening 91 in the bumper 90, in the manner that has been described above, the position of the nozzle cover 70 is also regulated properly relative to the opening 91 in the bumper 90. Consequently, the problem can be solved that there occurs a positionally unmatched condition or a positional deviation between the nozzle cover 70 and the opening 91 in the bumper 90 to thereby damage the external appearance of the bumper 90 and the opening and closing operations of the nozzle cover 70.

Note that should there be occurring a positional deviation between the nozzle cover 70 and the bracket 50 when the piston 20 is moved from the injecting position to the retracted position, the inclined edges 731, 731 and 742, 742 of the respective ribs 73, 73 and 74, 74 slide along internal edges at the front ends of the attachment pieces 523, 523 and the positioning walls 524, 524, 525 of the bracket 50, whereby the nozzle cover 70 is retracted into the normal position thereof.

Note that the shapes and constructions of the respective portions described in the embodiment constitute only one example of embodiments that will result when attempting to embody the invention, and therefore the technical scope of the invention should be limited by those described in the embodiment in no ways.

There is provided the headlamp cleaner for cleaning the front lens of the automotive headlamp, which is suitable for attachment to bumpers of vehicles.

While there has been described in connection with the preferred embodiments of the present invention, it will be obvious to those skilled in the art that various changes and modification may be made therein without departing from the present invention, and it is aimed, therefore, to cover in the appended claim all such changes and modifications as fall within the true spirit and scope of the present invention.

What is claimed is

1. A headlamp cleaner, comprising:
an injection nozzle for injecting cleaning fluid when in operation;
a piston supporting the injection nozzle;
a cylinder supporting the piston so that the piston moves between an injection position and a retracted position through an opening in a bumper; and
a nozzle cover mounted so as to move together with the piston to thereby open and close the opening in the bumper,
wherein an end portion of the cylinder is attached to the opening in the bumper via a bracket,
the bracket has a positioning wall situated on an inside of an edge of the opening in the bumper,
the nozzle cover has a positioning portion abutting with the positioning wall of the bracket, and
the positioning portion of the nozzle cover abuts with the positioning wall of the bracket so that the nozzle cover is positioned in place, when the piston is moved to the retracted position.

2. The headlamp cleaner as set forth in claim 1, wherein the bracket has an abutment wall, of which an end face abuts an opening edge portion on a back side of the bumper via an elastic member.

3. The headlamp cleaner as set forth in claim 2, wherein the abutment wall of the bracket is positioned so as to surround the positioning wall from an outside thereof.

4. The headlamp cleaner as set forth in claim 1, wherein the bumper has an engagement projection around the opening,
the bracket has an attachment piece having an engagement hole, and
the engagement hole in the attachment piece engages with the engagement projection on the bumper so that the bracket is fixed to the bumper.

5. The headlamp cleaner as set forth in claim 4, wherein the attachment piece and the positioning wall are arranged so as to form a quadrangle as viewed in a section taken along a plane which is perpendicular to a direction in which the piston moves, and
the nozzle cover has ribs which abut with the positioning wall and the attachment piece separately, so that the nozzle cover is positioned in place.

6. The headlamp cleaner as set forth in claim 1, wherein the bracket comprises:
a first connecting portion connecting the cylinder and the bumper to the bracket; and
a second connecting portion connecting the bumper to the bracket.

7. The headlamp cleaner as set forth in claim 6, wherein the first and second connecting portions are integral with each other.

8. The headlamp cleaner as set forth in claim 6, wherein the first connecting portion includes:
a cylindrical portion connected with a front end of the cylinder; and
a attachment piece connecting with a lower end of the bumper.

9. The headlamp cleaner as set forth in claim 6, wherein the positioning wall is provided on the second connecting portion.

10. The headlamp cleaner as set forth in claim 2, wherein the bracket comprises:
a first connecting portion connecting the cylinder and the bumper to the bracket; and
a second connecting portion having the abutment wall and connecting the bumper to the bracket.

11. The headlamp cleaner as set forth in claim 1, wherein the nozzle cover comprises:
a cover portion;
a attachment leg portion protruded from the cover portion to the cylinder for attaching the cover portion to the bracket;
a first rib extending in horizontal direction from the attachment leg portion and connected to the cover portion; and
a second rib extending in vertical direction from the attachment leg portion and connected to the cover portion.

12. The headlamp cleaner as set forth in claim 11, wherein the first rib comprising:
a positioning edge as the positioning portion, which is parallel to a cylinder axis to thereby determine the position of the nozzle cover in the horizontal direction; and
an inclined edge of which width is reduced toward to the cylinder side, and wherein the second rib comprising:
a positioning edge as the positioning portion, which is parallel to the cylinder axis to thereby determine vertical position of the nozzle cover; and
an inclined edge of which width is reduced toward to the cylinder side.
